(19) United States
(12) Patent Application Publication
(10) Pub. No.: US 2024/0172271 A1
(43) Pub. Date: May 23, 2024

(54) METHOD AND DEVICE FOR SIGNAL TRANSMISSION IN WIRELESS COMMUNICATION SYSTEM

(71) Applicant: Samsung Electronics Co., Ltd., Suwon-Si, Gyeonggi-do (KR)

(72) Inventors: Qi XIONG, Beijing (CN); Feifei SUN, Beijing (CN); Yi WANG, Beijing (CN)

(21) Appl. No.: 18/282,922

(22) PCT Filed: Mar. 28, 2022
(86) PCT No.: PCT/KR2022/004299

§ 371 Date: Sep. 19, 2023

(30) Foreign Application Priority Data
Mar. 26, 2021 (CN) 202110328032.4

(51) Int. Cl. H04W 74/00; H04L 5/00; H04W 72/044; H04W 72/51; H04W 74/0833

(52) U.S. Cl. CPC H04W 74/004; H04L 5/0048; H04W 72/046; H04W 72/51; H04W 74/006; H04W 74/0833

(57) ABSTRACT

The present disclosure provides a method performed by user equipment in a wireless communication system and the device thereof. The method comprises: receiving configuration information transmitted by a base station, wherein the configuration information includes at least one of random access resource configuration information or message 3 resource configuration information; determining, by the user equipment, at least one of random access resources or message 3 resources associated with a first operation according to the configuration information, when the user equipment is to perform the first operation; and transmitting at least one of a random access preamble or message 3 according to the determined resources.

### TECHNICAL FIELD

The disclosure relates to a method and equipment for signal transmission in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

In 5G systems, advanced coding modulation (ACM), such as hybrid FSK and QAM modulation (FQAM) and sliding window superposition coding (SWSC), and advanced access technologies, such as filter bank multicarrier (FBMC), non-orthogonal multiple access (NOMA) and sparse code multiple access (SCMA) have been developed.

### DISCLOSURE OF INVENTION

### Technical Problem

The present disclosure provides a method and an apparatus for (re-)transmitting a random access preamble or message 3 in a wireless communication system.

Further, the present disclosure provides a method and an apparatus for distinguishing between traditional UE which may not support new technical capabilities and new UE which may support new technical capabilities.

### Solution to Problem

According to one aspect of the present disclosure, there is provided a method performed by a user equipment in a wireless communication system, comprising: receiving configuration information transmitted by a base station, wherein the configuration information includes random access resource configuration information and/or message 3 resource configuration information; determining, by the user equipment, random access resources and/or message 3 resources associated with a first operation according to the configuration information, when the user equipment is to perform the first operation; and transmitting a random access preamble and/or message 3 according to the determined resources.

In another aspect of the present disclosure, there is provided a method executed by user equipment in a wireless communication system, wherein the random access resources include random access time-frequency resources and/or random access preamble, and wherein the random access resources include all or part of the random access resources with which each downlink beam is associated.

In another aspect of the present disclosure, there is provided a method performed by a user equipment in a wireless communication system, wherein the first operation includes at least one of the following: re-transmission of message 3, and reporting the supported specific technical features.

In another aspect of the present disclosure, there is provided a method executed by user equipment in a wireless communication system, wherein the configuration information includes at least one of the following: information indicating the number and/or position of random access occasions for the first operation under one downlink beam, and information indicating the number and/or position of random access preambles for the first operation in the random access occasion.

In another aspect of the present disclosure, there is provided a method executed by user equipment in a wireless communication system, wherein, when the random access occasion is shared with other random access occasions associated with the first operation, the configuration information includes information for indicating the number and/or position of random access preambles for the first operation in the random access occasions.

In another aspect of the present disclosure, there is provided a method executed by user equipment in a wireless communication system, wherein the message 3 resource configuration information includes at least one of time-frequency resource configuration and demodulation reference signal DMRS configuration.

In another aspect of the present disclosure, there is provided a method executed by user equipment in a wireless communication system, which further comprising: the user equipment determines whether to inform the base station that the user equipment supports specific technical features through random access resources or message 3 resource configurations by a specific method, wherein the specific method includes at least one of predefined rules and the indication of the base station.

In another aspect of the present disclosure, there is provided a method executed by user equipment in a wireless communication system, wherein determining whether to inform the base station that the user equipment supports specific technical features through random access resources or message 3 resource configurations through the indication of the base station includes: the user determines whether to inform the base station that the user equipment supports specific technical features through random access resources or message 3 resource configurations through the acquired high-level configuration information or the indication carried in the downlink control information; and/or when there is no configuration indication, the user equipment is configured by default based on random access resources.

In another aspect of the present disclosure, there is provided a method executed by a user equipment in a wireless communication system, wherein the first operation includes: re-transmission of message 3; determining message 3 resources associated with the first operation includes determining the types of frequency hopping and/or the patterns of frequency hopping.

In another aspect of the present disclosure, there is provided a method executed by user equipment in a wireless communication system, wherein the types of frequency hopping includes: inter-slot frequency hopping, intra-slot frequency hopping, both inter-slot frequency hopping and intra-slot frequency hopping, and no frequency hopping.

In another aspect of the present disclosure, there is provided a method performed by user equipment in a wireless communication system, wherein determining the types of frequency hopping includes: obtaining the determined types of frequency hopping by at least one of configuration of system information, configuration of downlink control information DCI, or configuration information in random access response.

In another aspect of the present disclosure, there is provided a method performed by user equipment in a wireless communication system, wherein the configuration information includes at least one of the following: information indicating the types of adopted frequency hopping; information for separately indicating the frequency hopping interval of inter-slot frequency hopping and the frequency hopping interval of intra-slot frequency hopping; information indicating one frequency hopping interval applied to both intra-slot frequency hopping and inter-slot frequency hopping; information indicating frequency hopping operation in a certain order.

In another aspect of the present disclosure, there is provided a method executed by user equipment in a wireless communication system, which further comprising: the user equipment supporting specific technical features obtains the first random access resource configured to the user equipment not supporting specific technical features in the system information block SIB message, wherein, if the configured first random access resource is all within the frequency range supported by the user equipment supporting specific technical features, the user equipment supporting specific technical features determines the frequency domain start position of the initial bandwidth part of the user equipment supporting specific technical features according to the frequency domain start position of the configured first random access occasion.

In another aspect of the present disclosure, there is provided a method executed by user equipment in a wireless communication system, which further comprising: the user equipment supporting specific technical features obtains the first random access resource configured to the user equipment not supporting specific technical features in the system information block SIB message, if the configured first random access occasion exceeds the bandwidth part BWP size supported by the user equipment supporting the specific technical features, the user equipment supporting the specific technical features determines the effective random access occasions, and associates the downlink beam with random access for the effective random access occasions.

In another aspect of the present disclosure, there is provided a method performed by a base station in a wireless communication system, comprising: transmitting configuration information to the user equipment, wherein the configuration information includes random access resource configuration information and/or message 3 resource configuration information; and receiving the random access preamble and/or message 3 transmitted by the user equipment, wherein the resources for transmitting the random access preamble and/or message 3 are the random access resources and/or message 3 resources associated with a first operation determined by the user equipment according to the configuration information when the user equipment is about to perform the first operation.

In another aspect of the present disclosure, there is provided a user equipment, which comprises a transceiver and a controller configured to receive configuration information transmitted by a base station, wherein the configuration information includes random access resource configuration information and/or message 3 resource configuration information; determine, by the user equipment, random access resources and/or message 3 resources associated with a first operation according to the configuration information, when the user equipment is to perform the first operation; and transmit a random access preamble and/or message 3 according to the determined resources.

In another aspect of the present disclosure, there is provided a base station, which includes a transceiver and a controller configured to transmit configuration information to the user equipment, wherein the configuration information includes random access resource configuration information and/or message 3 resource configuration information; and receive the random access preamble and/or message 3 transmitted by the user equipment, wherein the resources for transmitting the random access preamble and/or message 3 are the random access resources and/or message 3 resources associated with a first operation determined by the user equipment according to the configuration information when the user equipment is about to perform the first operation.

In another aspect of the present disclosure, there is provided an electronic device, including a memory configured to store a computer program; and a processor configured to run the computer program to implement the methods according to any one of the above embodiments.

### Advantageous Effects of Invention

According to an embodiment of the present disclosure, the frequency hopping type and frequency hopping pattern used in the re-transmission of message 3 can be determined.

According to an embodiment of the present disclosure, a network (base station) can distinguish between traditional UE which may not support new technical capabilities and new UE which may support new technical capabilities, and provide services for two types of UEs.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 shows a schematic diagram of an example wireless network 100 according to various embodiments of the present disclosure;

FIG. 2a shows a schematic diagram of an example wireless transmission path according to the present disclosure;

FIG. 2b shows a schematic diagram of an example wireless reception path according to the present disclosure;

FIG. 3a shows a schematic diagram of an example UE 116 according to the present disclosure;

FIG. 3b shows a schematic diagram of an example gNB 102 according to the present disclosure;

FIG. 4 is a schematic diagram showing random access procedure based on competition in LTE-A according to an embodiment of the present disclosure;

FIG. 5 is an example diagram showing user differentiation based on RACH resources of each SSB according to an embodiment of the present disclosure;

FIG. 6 is an example diagram showing that a plurality of different technical features are distinguished by preamble joints according to an embodiment of the present disclosure;

FIG. 7 is an example diagram showing simultaneous enabling of inter-slot frequency hopping and intra-slot frequency hopping according to an embodiment of the present disclosure;

FIG. 8 is an example diagram of the RedCap UE determining the initial BWP start position according to the embodiment of the present disclosure;

FIG. 9 is a schematic diagram showing user equipment that performs transmission of uplink signals according to an embodiment of the present disclosure;

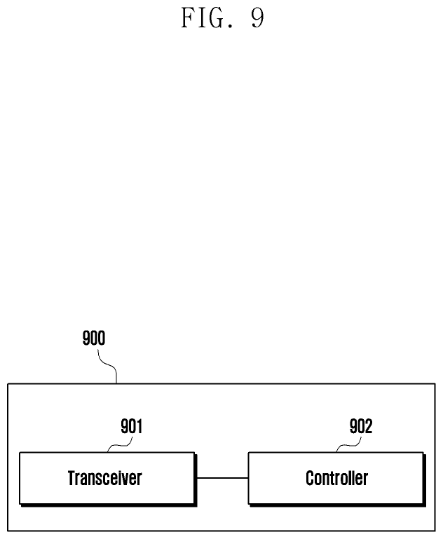

FIG. 10 is a schematic diagram showing a base station according to an embodiment of the present disclosure; and

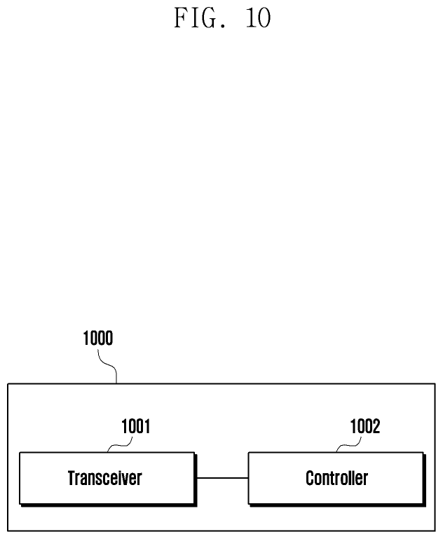

FIG. 11 is a schematic diagram showing an electronic device that performs transmission of an uplink signal according to an embodiment of the present disclosure.

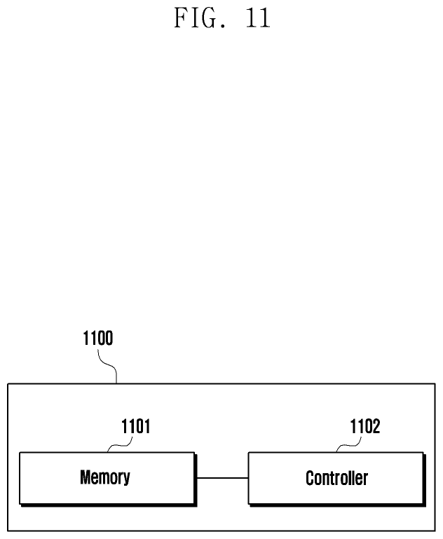

### MODE FOR THE INVENTION

The technical scheme of this embodiment can be applied to various communication systems, such as Global System for Mobile Communications (GSM) system, code division multiple access (CDMA), CDMA) system, Wideband Code Division Multiple Access (WCDMA) system, general packet radio service (GPRS), long term evolution (LTE), LTE) system, LTE frequency division duplex (FDD) system, LTE time division duplex (TDD), universal mobile telecommunications system (universal mobile telecommunication system, UMTS), worldwide interoperability for microwave access (WiMAX) communication system, 5th generation (5G) system or new radio (NR), etc. In addition, the technical scheme of the embodiment of this application can be applied to future-oriented communication technology.

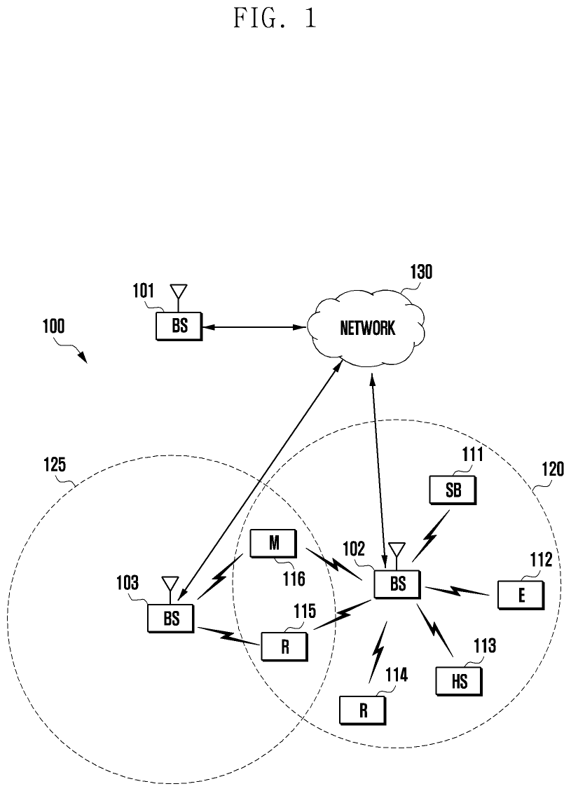

FIG. 1 shows an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

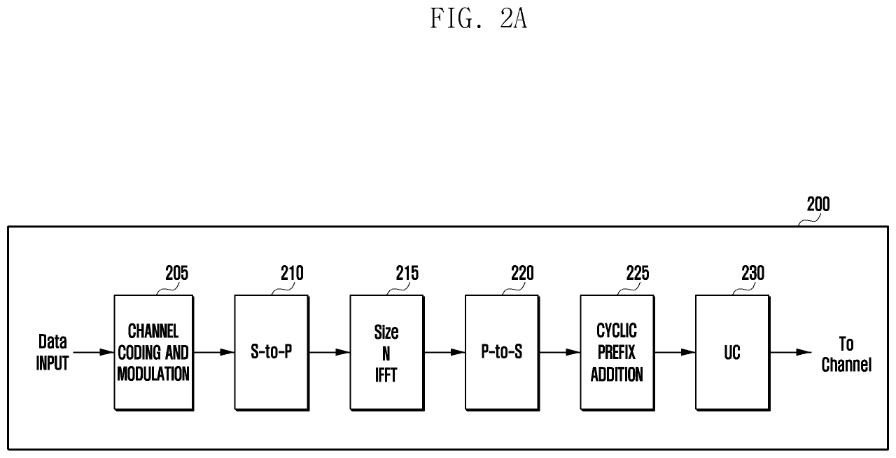

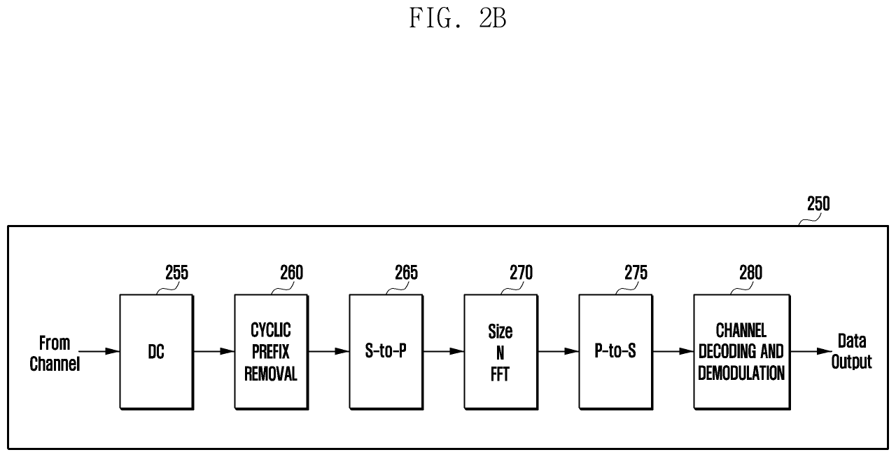

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The upconverter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

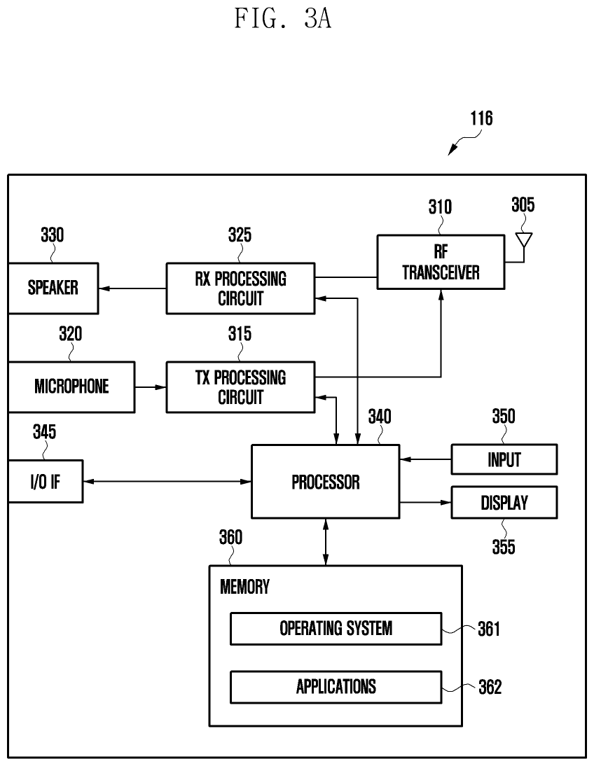

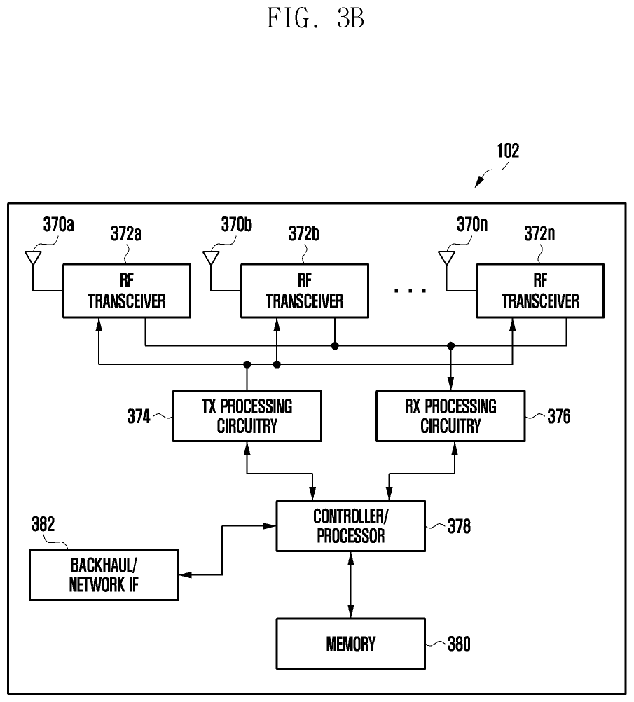

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Exemplary embodiments of the present disclosure are further described below with reference to the accompanying drawings.

Those skilled in the art can understand that the singular forms “a”, “an”, and “the” used here can also include plural forms unless specifically stated. It should be further understood that the word “comprising” used in the specification of this application means the presence of said features, integers, steps, operations, elements and/or components, but does not exclude the presence or addition of one or more other features, integers, steps, operations, elements, components and/or groups thereof. It should be understood that when an element is described as “connected” or “coupled” to another element, it may be directly connected or coupled to other elements, or there may be intervening elements. In addition, as used herein, the statements “connected” or “coupled” may include wireless connection or wireless coupling. As used herein, the phrase “and/or” includes all or any unit and all combinations of one or more associated listed items.

Those skilled in the art can understand that unless otherwise defined, all terms (including technical terms and scientific terms) used here have the same meaning as those commonly understood by ordinary technicians in the field to which this application belongs. It should also be understood that terms such as those defined in the general dictionary should be understood to have meanings consistent with those in the context of the prior art, and will not be interpreted with idealized or overly formal meanings unless specifically defined as here.

It can be understood by those skilled in the art that “terminal” and “terminal equipment” used here include not only the equipment including wireless signal receiver which is a wireless signal receiving equipment without capability of transmitting signals, but also the equipment including receiving and transmitting hardware which is capable of bidirectional communication on bidirectional communication link. Such devices may include: cellular or other communication devices with single-line display or multi-line display or cellular or other communication devices without multi-line display; PCS (Personal Communications Service), which can combine voice, data processing, fax and/or data communication capabilities; PDA (Personal Digital Assistant), which may include radio frequency receiver, pager, internet/intranet access, web browser, notepad, calendar and/or GPS (Global Positioning System) receiver; conventional laptops and/or palmtop computers or other devices having and/or including a radio frequency receiver. As used herein, “terminal” and “terminal equipment” can be portable, transportable, installed in the (aviation, maritime and/or land) transport, or suitable and/or configured to operate locally, and/or operate in any other place on the earth and/or space in a distributed manner. As used herein, “terminal” and “terminal equipment” can also be a communication terminal, an Internet terminal and a music/video playing terminal, such as PDA, MID (Mobile Internet Device) and/or a mobile phone with music/video playing functions, a smart TV, a set-top box and other devices.

The time domain unit (also called time unit) in this disclosure may be: an OFDM symbol, an OFDM symbol group (composed of multiple OFDM symbols), a time slot, a time slot group (composed of multiple time slots), a subframe, a subframe group (composed of multiple subframes), a system frame and a system frame group (composed of multiple system frames). And it can also be an absolute time unit, such as 1 millisecond, 1 second, etc. The time unit can also be a combination of various granularities, such as N1 time slots plus N2 OFDM symbols.

The frequency domain unit in this disclosure may be: a subcarrier, a subcarrier group (composed of multiple subcarriers), a resource block (RB), which can also be called a physical resource block (PRB), a resource block group (composed of multiple RBs), a band part (BWP), a band part group (composed of multiple BWPs), a band/carrier, a band group/carrier group. And it can also be an absolute frequency domain unit, such as 1 Hz, 1 kHz, etc. The frequency domain unit can also be a combination of various granularities, such as M1 PRBs plus M2 subcarriers.

And the text and drawings are provided as examples only to help readers understand the present disclosure. They are not intended and should not be interpreted as limiting the scope of the present disclosure in any way. Although some embodiments and examples have been provided, based on the disclosure herein, it is obvious to those skilled in the art that changes can be made to the illustrated embodiments and examples without departing from the scope of this disclosure.

Transmission in the wireless communication system includes: transmission from the base station (gNB) to the User Equipment (UE) (called downlink transmission) (and corresponding time slot is called downlink time slot), and transmission from UE to the base station (called uplink transmission) (and corresponding time slot is called uplink time slot).

In the downlink communication of wireless communication system, the system periodically transmits synchronization signals and broadcast channels to users through synchronization signal block (SSB), and the periodicity is called SSB periodicity or SSB burst periodicity. At the same time, the base station will configure a physical random access channel configuration period (PRACH configuration period), in which a certain number of random access transmission occasions (also called random access occasions, PRACH transmission occasion (RO)) are configured, and all SSBs in an association period (a certain length of time) can be mapped to the associated ROs. In a mapping cycle from SSB to RO, all SSBs in one SSB periodicity can be mapped to the required random access resources. There can be one or more mapping cycles in one association period. An association pattern period from SSB to RO contains one or more association periods, and the association pattern from SSB to RO in each association pattern period is the same.

In the New Radio (NR) communication system, before the establishment of radio resource control, such as in the random access procedure, the performance of random access directly affects the user experience. In traditional wireless communication systems, such as LTE and LTE-Advanced, the random access procedure is used in many scenarios, such as establishing initial link, cell handover, re-establishing uplink, RRC connection re-establishment, etc., and it is divided into Contention-based Random Access and Contention-free Random Access according to whether users monopolize preamble resources. In the Contention-based Random Access, each user chooses a preamble sequence from the same preamble sequence resources in the process of trying to establish uplink, and it is possible that multiple users choose the same preamble sequence to transmit to the base station. Therefore, the conflict resolution mechanism is an important research direction in random access, and how to reduce the probability of conflicts and how to quickly resolve the conflicts that have already occurred is the key index affecting the performance of random access.

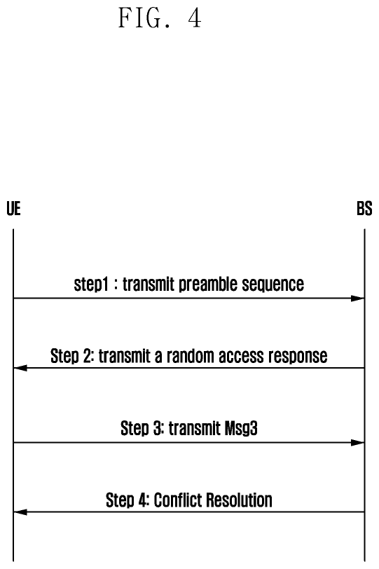

The Contention-based Random Access in LTE-A is divided into four steps, as shown in FIG. 4. In the first step, the user randomly selects a preamble sequence from the preamble sequence resource pool and transmits it to the base station. The base station detects the correlation of the received signals, so as to identify the preamble sequence transmitted by the user. In the second step, the base station transmits a Random Access Response (RAR) to the user, which includes a random access preamble sequence identifier, a timing advance instruction determined according to the time delay estimation between the user and the base station, a cell-radio network temporary identifier (C-RNTI), and time-frequency resources allocated for the next uplink transmission of the user. In the third step, the user transmits the message 3 (Msg3) to the base station according to the information in RAR. Msg3 contains information such as user terminal identification and RRC link request, wherein the user terminal identification is unique to the user and is used to resolve conflicts. In the fourth step, the base station transmits a conflict resolution identification to the user, which includes the user terminal identification that won in the conflict resolution. After the user detects his own identification, it upgrades the temporary C-RNTI to C-RNTI, transmits an ACK signal to the base station, completes the random access procedure, and waits for the scheduling of the base station. Otherwise, the user will start a new random access procedure after a delay.

For the Contention-free Random Access, because the base station knows the user identification, the preamble sequence can be assigned to the user. Therefore, when transmitting the preamble sequence, the user does not need to randomly select the sequence, but will use the assigned preamble sequence. After detecting the assigned preamble sequence, the base station will transmit a associated random access response, including timing advance information, uplink resource allocation and other information. After receiving the random access response, the user thinks that the uplink synchronization has been completed and waits for further scheduling by the base station. Therefore, the Contention-free Random Access includes two steps: step one is to transmit the preamble sequence; and step two is to transmit the random access response.

Random access procedure in LTE is suitable for the following scenarios:
1. Initial access in RRC_idle;
2. Re-establish RRC connection;
3. Cell handover;
4. Downlink data arriving and requesting random access procedure in RRC connection state (when the uplink is asynchronous);
5. Uplink data arriving and requesting random access procedure in RRC connection state (when the uplink is asynchronous or no resource in PUCCH resources is allocated to scheduling request);
6. Positioning.

In some network systems, such as 5G NR system, it is possible to support the retransmission of message 3 in the case of beamforming and/or limited coverage. However, how to determine the frequency hopping type and frequency hopping pattern used in the re-transmission of message 3 is an unsolved problem. Meanwhile, because of the introduction of new technical capabilities, there may be traditional users (that is, users who may not support new technical capabilities) and new users (that is, users who may support new technical capabilities) in a network system, so whether it is necessary to distinguish the users at the initial access stage and how to distinguish them is also a problem to be solved.

Specifically, in this embodiment, a method and device for uplink signals transmission will be introduced. In a service network, some new technical features may be continuously introduced, so there are two types of UE, one is user equipment that does not support new technical features (such as legacy UE), the other is new user equipment that supports new technical features (new UE). In the process of providing services, a network device may need to provide services for these two types of users at the same time, so it is necessary for UE to inform the network device whether it supports (or needs to use) new technical features through certain methods.

Among others, the new technical features include but are not limited to the following listed technical features:
Coverage enhancement; or (message 3 repetition, msg3 repetition);
Ordinary (Reduced) (Reduced Capability, RedCap)
Small data transmission (SDT)
2-step random access (2-2step RACH)

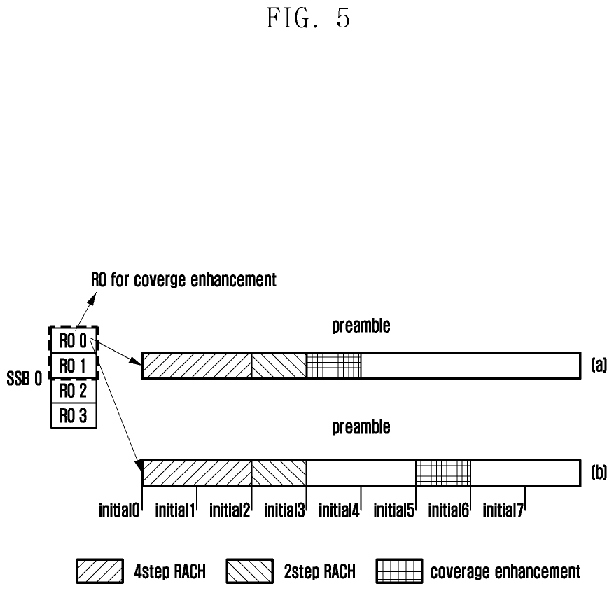

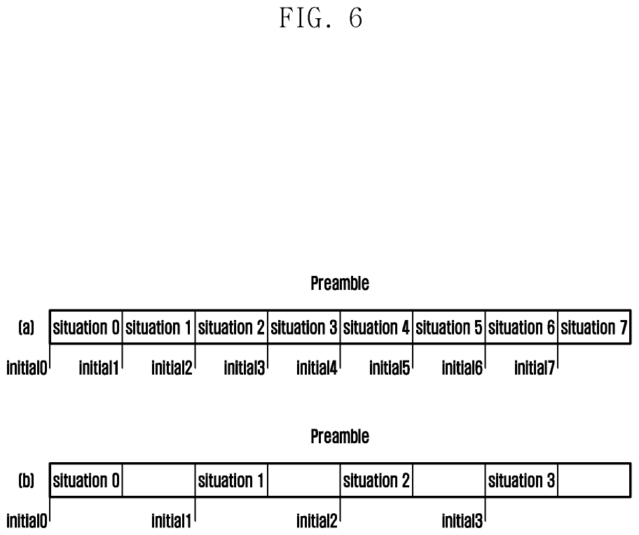

Unless otherwise specified, the coverage enhancement is used in the following as an example to illustrate the method provided by the present disclosure. Among others, the certain methods can be a combination of one or more of the following:
The UE can inform the base station that it supports or needs to use the new technical features through different random access resources (that is, the UE that supports the new technical features can choose random access resources different from the legacy UE). The different random access resources can be different random access time-frequency resources (also called random access occasion (RACH transmission occasion, RO) and/or different random access preamble resources). Specifically, the UE obtains random access time-frequency resources (also called random access occasion (RACH transmission occasion, RO) and/or random access preamble resources) for the new technical features through the configuration information of the base station. When the UE wants to inform the base station that it supports or needs to use the new technical features, the UE uses the associated random access resources or randomly selects from the associated random access resources;
   Preferably, the different random access resources mentioned above may refer to all or a part of the random access resources associated to each downlink beam (such as SSB or CSI-RS), that is, the obtained random access resources for different technical features are obtained after the association between the downlink beam and the random resources is completed. And the configured different random access resources (such as random access occasions and/or random access preambles) are applied to each downlink beam, by the following specific ways:
      Configuring the number and position of random access occasions (ROs) for one technical feature under a downlink beam. The specific method can be bit map method (for example, if one SSB is associated with four ROs, then, for new technical features, RO0 and RO1 are represented by a 4-bit bit map, such as “1100”); look-up table method, for example, for the configuration of 16 rows, one or more RO indexes are available for each row configuration; predefined method, for example, if the number of ROs suitable for new technical features is configured as 2 (in the situation that one SSB is associated with four ROs), ROs suitable for new technical features could be specified from the beginning (namely RO 0 and RO1) or from the end (namely RO3 and RO2); and/or
      Configuring the number and position of random access preamble for one technical feature in an RO. The number can be selected from a numerical set, for example, 2 bits are selected from a numerical set containing 4 values. The confirmation of the position of the configured preamble is mainly depended on the confirmation of the start position. The method can be that the first preamble after the last preamble of 2-step random access is the start position of the preamble by default (as shown in case a in FIG. 5, SSB0 is associated with 4 ROs, and RO0 and RO1 are used for the indication of coverage enhancement. Each RO has 64 preambles, and 8 preambles after 2-step random access are the preambles for the coverage enhancement). Or the method can directly indicate the start position, for example, by indicating one of the preset start positions. For example, as shown in case b in FIG. 5, SSB0 is associated with four ROs, and RO0 and RO1 are used for indication of coverage enhancement. Each RO has 64 preambles, and the number of preambles for the coverage enhancement that directly indicated by the UE through the base station is 8, and the start position is the start position 5 (that is, 3 bits indicate possible 8 positions);
      The above method of configuring the number and position of random access preambles for one technical feature in an RO can also be used for sharing an RO with other technical features;
The UE can inform the base station that it supports or needs to use the new technical features by configuring different message 3 resources (that is, the UE that supports the new technical features can choose different message 3 resources from the legacy UE to transmit the message 3 PUSCH). The different message 3 configurations can be at least one of the following:
   Different time-frequency resources;
   Different demodulation reference signal DMRS configurations (including different DMRS ports and/or different DMRS sequences);
The UE can determine whether to inform the base station that it supports or needs to use new technical features through different RACH resource configurations or different message 3 resource configurations in a specific way. The specific method can be at least one of the following:
   Determining by the indication of the base station. The UE determines whether to inform the base station that it supports or needs to use new technical features through different RACH resource configurations or different Message 3 resource configurations by the acquired high-level configuration information (such as system messages) or the distinguishing user indication carried in DCI. Particularly, when there is no configuration indication, UE uses different RACH resource configurations by default. This method can make the base station to flexibly choose according to the current configuration and its own ability;
   Adopting predefined rules. For example, if the UE determines that the RACH resources have been used for more than (or not less than) N technical features, or N times of partition through the acquired high-level configuration information (such as system messages) or the configuration information in DCI, the UE expects to use different message 3 configurations, otherwise the UE expects to use different random access resource configurations;
Preferably, different random access resource configurations and/or different resource configurations of message 3 can be jointly designed to indicate a combination of different technical features. The following is an example of a network device that needs to distinguish three new technical features at the same time: Coverage enhancement (CovEnh), Ordinary capability (RedCap) and Small data transmission (SDT). The method can be extended to other cases with different number of technical characteristics.
   Considering whether the three new technical feature combination are supported or not, there are the following possible N=8 situation:
      Situation 0: none of the three are supported (such as Legacy UE);
      Situation 1: supporting CovEnh, supporting RedCap, and not supporting SDT;
      Situation 2: supporting CovEnh, not supporting RedCap, and supporting SDT;
      Situation 3: not supporting CovEnh, supporting RedCap, and supporting SDT;
      Situation 4: supporting CovEnh, not supporting RedCap, and not supporting SDT;
      Situation 5: not supporting CovEnh, supporting RedCap, and not supporting SDT;
      Situation 6: not supporting CovEnh, not supporting RedCap, and supporting SDT;
      Situation 7: supporting CovEnh, supporting RedCap, and supporting SDT;
   The methods of joint differentiation include at least one of the following:
      Through individual RO configurations, that is, for each situation, there are individual ROs to choose from. Particularly, after SSB-RO association, individual ROs are configured in ROs associated with each SSB; and/or
      Through individual preambles configurations, that is, for each situation, individual preambles are configured, and the preambles are equally divided according to possible situations according to the total number of available preambles. For example, there are N_total=64 preambles in an RO, which are divided into N=8 segments, that is, N_total/N=64/8=8 preambles in each segment, which respectively represent individual situations according to the predefined order, as shown in FIG. 6(a).
      Particularly, the number of preambles occupied by each situation is additionally configured, the start position of each situation is obtained by evenly dividing the number of situations and the total available preambles, and then the number of preambles occupied by each situation is applied from the start position. For example, there are four situations in total and N_total=64 preambles. Four start positions are divided, and each situation is configured with eight preambles. As shown in FIG. 6(b), each situation occupies eight preambles according to the associated start position.
      Particularly, a look-up table is used. For example, three bits are used to indicate that the random access preamble for one situation indicates a configuration mode in the configuration table for the configuration information of the preamble in any situation. The configuration information can include the start preamble position (such as start preamble index) and the number of occupied preambles for any situation. As exemplified in Table 1, the start index value and/or the number of occupied preamble can be selected from the associated available value set;

TABLE 1
Random Access Preamble Indication Configuration Table

| Index | Start index | Number of occupied |
|---|---|---|
| value | value | preambles |
| 0 | 0 | 8 |
| 1 | 8 | 4 |
| 2 | 16 | 4 |
| 3 | 24 | 4 |
| 4 | 32 | 2 |
| 5 | 40 | 2 |
| 6 | 48 | 2 |
| 7 | 56 | 1 |

Individual configurations of message 3 are jointly used for the distinguishing. For example, if 8 situations need to be distinguished, 8 individual DMRS resources (DMRS port and/or DMRS sequence) are used to indicate respectively. That is, when the UE supports any situation, the associated DMRS resources are selected to transmit message 3, and in particular, a specific repeated PUSCH (such as the first repeated PUSCH) of message 3 is transmitted;
Alternatively, individual combinations of random access resources and message 3 are jointly used for the distinguishing. For example, if 8 situations need to be distinguished, 4 group of individual random access resources are used to distinguish 4 situation groups. Each situation group contains two situations, and two individual situations in one situation group are distinguished by 2 individual message 3 resource configurations.

When the UE decides or triggers the re-transmission of message 3, it also needs to determine the type of frequency hopping and the pattern of frequency hopping through the configuration information. Among others, the types of frequency hopping includes at least one of the following:
Type 1: based on inter-slot frequency hopping (inter-slot FH);
Type 2: based on intra-slot frequency hopping (intra-slot FH);
Type 3: both inter-slot FH and intra-slot FH;
Type 4: no frequency hopping.

Among others, the UE determines the frequency domain start position of the second hop by the frequency domain start position (RBstart) of the first hop, the frequency domain interval (RBoffset) between two adjacent hops (which is also called the frequency hopping interval in the present disclosure), and the band part size (BWP size, NBWPsize) where the uplink signal is located.

$${RB}_{start} = \{ \begin{matrix}{RB}_{start} & First hop \\ ( {RB}_{start} + {RB}_{offset} ) mod {N}_{BWP}^{size} & Second hop\end{matrix}$$

The specific method of determining the type of frequency hopping through the configuration information can include at least one of the following:
Obtaining through the configuration of system information (such as SIB1 or dedicated SIB);
Obtaining through the configuration of DCI (for example, in DCI for scheduling random access response, through PDCCH scrambled by RA-RNTI in the message 2 of contention-free two-step random access or contention-based four-step random access, or PDCCH scrambled by MsgB-RNTI in the message B of contention-based two-step random access, etc.);
Obtaining through the configuration in the random access response.

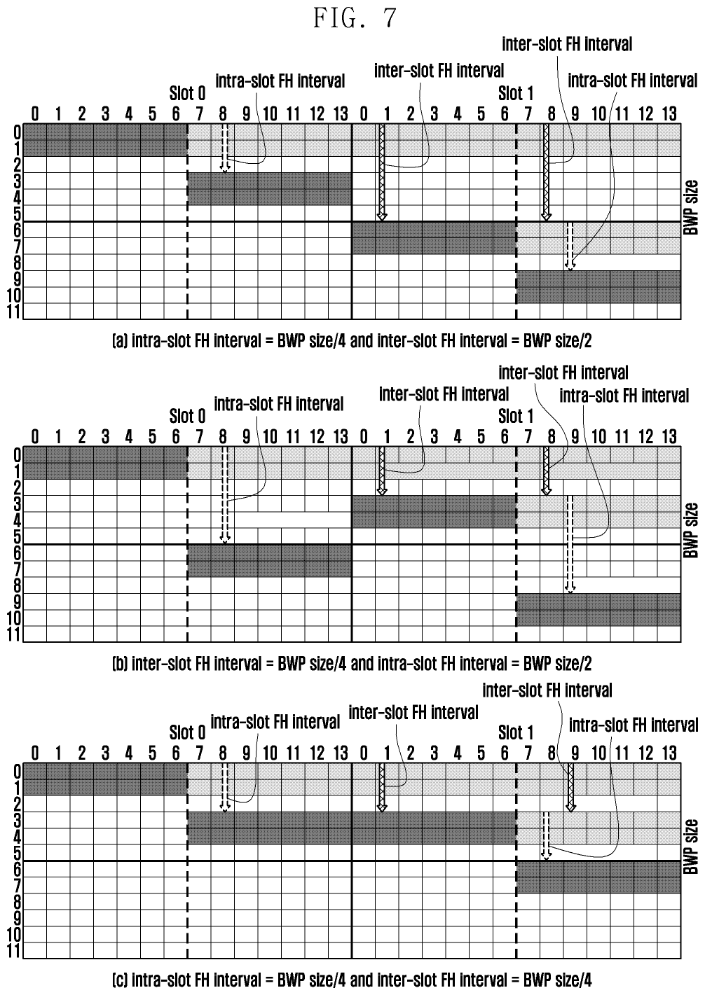

The configuration can include one of the following methods:
Using 1 bit to indicate which frequency hopping mode is adopted (not the enabling of the frequency hopping mode), for example, 1 represents intra slot FH and 0 represents interslot FH; and/or using 1 bit to indicate whether the indicated frequency hopping mode is enabled;
Using 1 bit to indicate whether intra slot FH is enabled or not, for example, in the RAR process of legacy UE, ibit is used to indicate whether intra slot FH is enabled or not;
Adding 1 bit (or reusing ibit reserved bit) to indicate whether inter slot FH is enabled or not, for example, adding 1 bit or reusing 1 bit reserved bit in RAR for indication. Particularly, when the UE does not expect the two frequency hopping modes to be enabled at the same time, for example, a specific indication mode may be: when the intra slot FH indication bit is 1 (enabled), the UE may ignore the indication bit of the intra slot FH indication; and when the intra slot FH indication bit is 0 (not enabled), the UE may enable the inter slot FH according to the inter slot FH indication bit;
Using the indications of the two bits to jointly indicate or individually indicate, if intra slot FH and inter slot FH are supported to be enabled at the same time. Particularly, when two types of frequency hopping FH are enabled at the same time, the UE needs to determine the pattern of FH (that is, the start positions of different hops) in a certain way, which can include at least one of the following:
   Indicating the frequency hopping interval of intra-slot frequency hopping and inter-slot frequency hopping separately. One method is to obtain the intra-slot frequency hopping indication bits and/or inter-slot frequency hopping indication bits through the X1+X2 bits (from high bit to low bit) indicated by frequency domain resources, according to a certain order (for example, the first X1 bits are intra-slot frequency hopping, and the second X2 bits are inter-slot frequency hopping or vice versa); and the value indicated by the frequency hopping indication bit can be obtained by looking up the table. Preferably, the frequency hopping interval of intra-slot frequency hopping can be smaller than that of inter-slot frequency hopping (as illustrated in FIG. 7(a)); or the frequency hopping interval of intra-slot frequency hopping may be larger than that of inter-slot frequency hopping (as illustrated in FIG. 7(b)); or the frequency hopping interval of intra-slot frequency hopping can be equal to that of inter-slot frequency hopping (as illustrated in FIG. 7(c));
   Indicating that one frequency hopping interval is applied to both intra-slot frequency hopping and inter-slot frequency hopping, that is, intra-slot frequency hopping and inter-slot frequency hopping use the same frequency hopping interval. One method is that the X bits from high bit to low bit indicated by frequency domain resources are frequency hopping interval indication bits; and the value indicated by the frequency hopping indication bit can be obtained by looking up the table.
   Particularly, UE can perform frequency hopping operation according to a certain order (to get the resource position after frequency hopping). For example, interslot frequency hopping can be operated before intra-slot frequency hopping. The advantage of the above operation is that the transmission of a slot is treated as a whole, and the frequency hopping in the slot can be treated as a frequency hopping operation within a single entity; or vice versa.
The “slot” in the above inter-slot frequency hopping and intra-slot frequency hopping can be replaced by a PUSCH transmission occasion, that is, frequency-domain frequency hopping is performed with a nominal or actual transmission size of PUSCH.

In another embodiment of the present disclosure, it is also introduced that in new technical features (such as RedCap), the BWP size that may be supported by the UE supporting the new technical features is different from that of the legacy UE. For example, in the initial access process, the BWP size supported by the UE supporting RedCap may be smaller than that supported by the legacy UE, and through the method provided by the present disclosure, the available random access resources can be determined by the redcap UE.

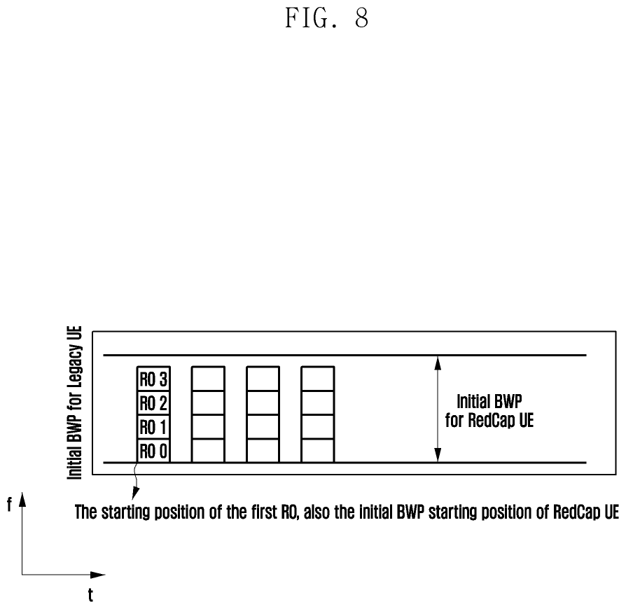

Without additional allocating initial BWP or RACH resources for Redcap, Redcap UE will also acquire RACH resources configured to legacy UE in SIB message. The specific treatment methods include at least one of the following:
If the configured RACH resources are all within the frequency range supported by the RedCap UE, the configured RACH resources are all available. Particularly, the RedCap UE can determine the frequency domain start position of the initial bandwidth part for the RedCap UE according to the frequency domain start position of the first configured RO (in frequency domain), as illustrate in FIG. 8. Particularly, the first configured RO can also be the first effective and/or available RO;
If the configured RO exceeds the BWP size range (including part and/or all of it) supported by RedCap UE, the RO is unavailable or invalid RO for RedCap UE. Particularly, RedCap UE only associates downlink beams (such as SSB/CSI-RS) with RACH for effective (or available) ROs;
Particularly, the above methods can be applied to other new technical features.

The embodiment also provides a user equipment 900 for transmitting uplink signals. The user equipment 900 includes a transceiver 901 and a controller 902, wherein the transceiver 901 is used for receiving signals from a base station and transmitting uplink signals to the base station; the controller 902 is configured to receive signals from the transceiver 901 and transmit signals to the transceiver 901. In addition, the controller 902 is further configured to receive configuration information transmitted by the base station, wherein the configuration information include random access resource configuration information and/or message 3 resource configuration information. When the UE is to perform a first operation, the UE determines random access resources and/or message 3 resources associated with the first operation according to the configuration information; and transmits the random access preamble and/or message 3 according to the determined resources.

The embodiment also provides a base station 1000 for transmitting uplink signals. The base station 1000 includes a transceiver 1001 and a controller 1002, wherein the transceiver 1001 is used to receive signals from and transmit signals to user equipment, and the controller 1002 is configured to receive signals from and transmit signals to the transceiver 1001. In addition, the controller 1002 is further configured to transmit configuration information to the user equipment, wherein the configuration information includes random access resource configuration information and/or message 3 resource configuration information; and to receive the random access preamble and/or message 3 transmitted by the user equipment, wherein the resources for transmitting the random access preamble and/or message 3 are the random access resources and/or message 3 resources associated with a first operation determined by the user equipment according to the configuration information when the user equipment is about to perform the first operation.

The embodiment also provides an electronic device 1100 for signal transmission. The user equipment includes a memory 1101 and a processor 1102, and the memory 1101 stores computer-executable instructions. When the instructions are executed by the processor 1102, at least one method associated with the above embodiments of the disclosure is executed.

The disclosure also provides a computer-readable medium on which computer-executable instructions are stored, which, when executed, perform any of the methods described in the embodiments of the disclosure.

As used herein, “user equipment” or “UE” can refer to any terminal with wireless communication capability, including but not limited to mobile phones, cellular phones, smart phones or personal digital assistants (PDA), portable computers, image capturing devices such as digital cameras, game devices, music storage and playback devices, and any portable unit or terminal with wireless communication capability, or Internet facilities that allow wireless Internet access and browsing, etc.

As used herein, the term “base station” (BS) or “network equipment” can refer to eNB, eNodeB, NodeB, or base transceiver station (BTS) or gNB, etc., according to the used technology and terminology.

The “memory” here may be of any type suitable for the technical environment of this document, and can be implemented using any suitable data storage technology, including but not limited to semiconductor-based memory devices, magnetic memory devices and systems, optical memory devices and systems, fixed memory and mobile storage.

The processor here may be of any type suitable for the technical environment of this document, including but not limited to one or more of the following: general-purpose computers, special-purpose computers, microprocessors, digital signal processors DSPs, and processors based on a multi-core processor architecture.

The above description is only the preferred embodiment of the present disclosure, and it is not intended to limit the present disclosure. Any modification, equivalent replacement, improvement, etc. made within the spirit and principle of the present disclosure should be included in the scope of the present disclosure.

It can be understood by those skilled in the art that the present disclosure includes devices for performing one or more of the operations described in this application. These devices can be specially designed and manufactured for the required purposes, or they can also include known devices in general-purpose computers. These devices have stored therein computer programs that are selectively activated or reconfigured. Such a computer program can be stored in a device (e.g., computer) readable medium or in any type of medium suitable for storing electronic instructions and respectively coupled to a bus, including but not limited to any type of disk (including floppy disk, hard disk, optical disk, CD-ROM, and magneto-optical disk), ROM (Read-Only Memory), RAM (Random Access Memory), EPROM (erasable programmable read-only memory), EEPROM (electrically erasable programmable read-only memory), flash memory, magnetic card or optical card. That is, a readable medium includes any medium that stores or transmits information in a readable form by a device (e.g., a computer).

It can be understood by those skilled in the art that each block in these structural diagrams and/or block diagrams and/or flow diagrams and combinations of blocks in these structural diagrams and/or block diagrams and/or flow diagrams can be implemented by computer program instructions. Those skilled in the art can understand that these computer program instructions can be provided to a processor of a general-purpose computer, a professional computer or other programmable data processing methods for implementation, so that the scheme specified in the block or blocks of the structure diagram and/or block diagram and/or flow diagram disclosed by the present disclosure can be executed by the processor of the computer or other programmable data processing methods.

Those skilled in the art can understand that the steps, measures and schemes in various operations, methods and processes already discussed in the present disclosure can be alternated, changed, combined or deleted. Furthermore, other steps, measures and schemes in various operations, methods and processes already discussed in the present disclosure can also be alternated, changed, rearranged, decomposed, combined or deleted. Furthermore, the steps, measures and schemes in various operations, methods and processes disclosed in the prior art can also be alternated, changed, rearranged, decomposed, combined or deleted.

The above is only a partial embodiment of the present disclosure. It should be pointed out that for those skilled in the art, without departing from the principle of the present disclosure, several improvements and embellishments can be made, which should also be regarded as the protection scope of the present disclosure.

1. A method performed by a user equipment in a wireless communication system, the method comprising:
receiving, from a base station, configuration information, wherein the configuration information includes at least one of random access resource configuration information or message 3 resource configuration information;
determining, by the user equipment, at least one of random access resources or message 3 resources associated with a first operation according to the configuration information, when the user equipment is to perform the first operation; and
transmitting at least one of a random access preamble or message 3 according to the determined resources.

2. The method of claim 1,
wherein the random access resources include random access time-frequency resources or random access preamble, and
wherein the random access resources include all or part of the random access resources with which each downlink beam is associated.

3. The method of claim 1, wherein the first operation includes at least one of the following: re-transmission of message 3, or reporting the supported specific technical features.

4. The method of claim 2, wherein the configuration information includes at least one of the following:
information indicating a number or position of random access occasions for the first operation under one downlink beam, or
information indicating a number or position of random access preambles for the first operation in the random access occasion.

5. The method of claim 4, wherein,
in case that the random access occasion is shared with other random access occasions associated with the first operation, the configuration information includes information for indicating the number or position of random access preambles for the first operation in the random access occasions.

6. The method of claim 1, wherein the message 3 resource configuration information includes at least one of time-frequency resource configuration and demodulation reference signal DMRS configuration.

7. The method of claim 3, further comprising:
determining whether to inform the base station that the user equipment supports specific technical features through random access resources or message 3 resource configurations by a specific method,
wherein the specific method includes at least one of the predefined rules or the indication of the base station.

8. The method of claim 7, wherein,
determining whether to inform the base station that the user equipment supports specific technical features through random access resources or message 3 resource configurations through the indication of the base station includes:
determining whether to inform the base station that the user equipment supports specific technical features through random access resources or message 3 resource configurations by the acquired high-level configuration information or the indication carried in the downlink control information; and
when there is no configuration indication, the user equipment is configured by default based on random access resources.

9. The method of claim 1,
wherein the first operation includes re-transmission of message 3; and
wherein determining message 3 resources associated with the first operation includes determining the types of frequency hopping and the patterns of frequency hopping.

10. The method of claim 9, wherein,
the types of frequency hopping includes: inter-slot frequency hopping,
intra-slot frequency hopping, both inter-slot frequency hopping and intra-slot frequency hopping, and no frequency hopping.

11. The method of claim 9, wherein determining the types of frequency hopping includes: obtaining the determined types of frequency hopping by at least one of the configuration of system information, the configuration of downlink control information DCI, or the configuration information in random access response.

12. The method of claim 9, wherein the configuration information includes at least one of the following:
information indicating the types of adopted frequency hopping;
information for separately indicating the frequency hopping interval of inter-slot frequency hopping and the frequency hopping interval of intra-slot frequency hopping;
information indicating one frequency hopping interval applied to both intra-slot frequency hopping and inter-slot frequency hopping; or
information indicating frequency hopping operation in a certain order.

13. The method of claim 3, further comprising:
in case that the user equipment supports specific technical features, obtaining the first random access resource configured to a user equipment not supporting specific technical features in the system information block SIB message,
wherein, in case that the configured first random access resource is all within the frequency range supported by the user equipment supporting specific technical features, the user equipment supporting specific technical features determines the frequency domain start position of the initial bandwidth part of the user equipment supporting specific technical features according to the frequency domain start position of the configured first random access occasion.

14. The method of claim 3, further comprising:
in case that the user equipment supports specific technical features, obtaining the first random access resource configured to a user equipment not supporting specific technical features in the system information block SIB message,
in case that the configured first random access occasion exceeds the bandwidth part BWP size supported by the user equipment supporting the specific technical features, the user equipment supporting the specific technical features determines the effective random access occasions, and associates the downlink beam with random access for the effective random access occasions.

15. A method performed by a base station in a wireless communication system, the method comprising:
transmitting, to a user equipment, configuration information, wherein the configuration information includes at least one of random access resource configuration information or message 3 resource configuration information; and
receiving, from the user equipment, at least one of the random access preamble or message 3,
wherein resources for receiving at least one of the random access preamble or message 3 are the random access resources or message 3 resources associated with a first operation determined by the user equipment according to the configuration information when the user equipment is about to perform the first operation.
